(19) United States
(12) Patent Application Publication
(10) Pub. No.: US 2008/0098051 A1
(43) Pub. Date: Apr. 24, 2008

(54) Managing Data Space on a Record Carrier

(75) Inventors: Johannis Friso Rendert Blacquiere, Eindhoven (NL); Pope Ijtsma, Eindhoven (NL); Christiaan Edzard Van Haersma Buma, Eindhoven (NL); Wiebe De Haan, Eindhoven (NL); Dirk Hamelinck, Beerzel (BE); Wilhelmus Jacobus Van Gestel, Heeze (NL); Johannes Jan Mons, Eindhoven (NL); Menno Anne Treffers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,614

(22) PCT Filed: Jul. 19, 2005
(86) PCT No.: PCT/IB05/52409

§ 371 Date: Jan. 24, 2007

(30) Foreign Application Priority Data
Jul. 28, 2004 (EP) 04103603.9

(51) Int. Cl. G06F 12/02

(52) U.S. Cl. 707/205; 707/E17.01; 711/E12.078

(57) ABSTRACT

A recording system records blocks of information on a record carrier according to a file management system. Data space on a partly and fragmented recorded record carrier (60-68) is managed as follows. The information includes a first type of information, such as video, and a second type, such a general purpose data. The first type has extent allocation requirements that include requiring an extent to accommodate a multitude of information blocks in a consecutive range of addresses and the extent to have at least a predetermined extent size. Data space is managed by selecting at least one partly recorded data area (67,63,68) of at least the extent size which data area contains information blocks (63) at recorded addresses, and subsequently creating a free data area (74) on the record carrier by moving the information blocks from the recorded addresses in the partly recorded data area to different addresses (73) outside the free data area (74) and correspondingly adapting the file management data.

The invention relates to a method of managing data space on a record carrier for use in recording information in blocks located according to file management data of a file management system.

The invention further relates to a device for recording information in blocks on a record carrier, which device comprises recording means for recording marks in a track on the record carrier representing the information, and control means for controlling the recording by locating the information blocks in the track according to file management data of a file management system.

The invention further relates to a computer program product for managing data space on a record carrier.

A device for recording information and method of managing data space on a record carrier are known from U.S. Pat. No. 5,930,828. The document relates to disc-like record carriers, such as a hard disk drive in a computer, on which files are stored via a file management system such as the Windows (trademark of Microsoft Corporation) operating system. Other types of disc-like record carriers are optical record carriers such as CD or DVD. Recording devices have recording means for recording the information in information blocks having addresses on the disc.

The document describes a defragmentation process of the disc, which contains files recorded at various instants in the past. Due to the recording history the recorded parts of the files, also called extents, are spread across the disc. The defragmentation process determines which files have a high degree of fragmentation, and moves the corresponding file extents on the disc to a selected location. In this manner fragmented files and fragmented free space on the disc are made contiguous. Files are moved toward the front of the disc where possible. When the fragmentation process is complete, contiguous files tend to be packed toward the front of the disc with defragmented free space tending to be located toward the end of the disc.

A problem of recording real-time information is that the requirements for speed and performance of the recording device are high. When recording real-time information such information requires the recorded information blocks to be contiguous according to additional allocation requirements, which require contiguous free data area. However, if the known defragmentation process is to be performed, a substantial amount of time is needed for such defragmentation.

It is an object of the invention to provide a system of managing data space on a record carrier that facilitates storing information that has additional allocation requirements while maintaining a high performance.

For this purpose, the method of managing data space as described in the opening paragraph is for recording a first type of information having extent allocation requirements that include requiring an extent to accommodate a multitude of information blocks in a substantially consecutive range of addresses and the extent to have at least a predetermined extent size, and a second type of information having no extent allocation requirements, and the method comprises selecting at least one partly recorded data area of at least the extent size which data area contains information blocks at recorded addresses, and creating a free data area on the record carrier by moving the information blocks from the recorded addresses in the partly recorded data area to different addresses outside the free data area and correspondingly adapting the file management data.

For this purpose, in the device as described in the opening paragraph for recording the information as described above, the control means comprise selection means for selecting at least one partly recorded data area of at least the extent size which data area contains information blocks at recorded addresses, and clearing means for creating a free data area on the record carrier by moving the information blocks from the recorded addresses in the partly recorded data area to different addresses outside the free data area and correspondingly adapting the file management data.

The partly recorded area is a contiguous part of the address space having at least the size of the minimum extent, which is partly recorded and partly free. It is noted that in this document partly recorded is not related to disc having virgin areas that never have been written, but means containing valid data (files) and still having data space available. Hence available free areas do not contain currently valid data, but may or may not have been written earlier. The measures have the effect that free data areas are created according to the extent allocation requirements of the first type of information. The amount of fragmentation of existing files is not detected or purposely changed, but only free areas are created that are sufficiently large to accommodate an extent of the size as required by new information to be recorded. This has the advantage that only a limited amount of existing information blocks needs to be moved, and therefore the clearing process will be quick.

The invention is also based on the following recognition. Some types of information, e.g. real-time information like video, require contiguous data areas of a substantial size to comply with playback requirements. However, the size of the contiguous data areas required is defined by predefined allocation rules. The so-called extent allocation requirements usually include a minimum extent size for such types of information. On a partly recorded disc the remaining space may be scattered and a number of smaller free areas remain. Although a single large contiguous space might be achieved by the traditional defragmentation process, this is very time consuming. In addition the inventors have realized that there is no immanent need to reorder the existing files, but only to clear partly recorded areas by moving some recorded parts of existing files that interrupt the free space. By selecting partly recorded areas that are potentially clearable to free areas of sufficient size to contain at least one extent of the new information to be recorded, and subsequently move any information blocks that are within the partly recorded area, the required free data areas are created with a limited effort.

In an embodiment of the method said selecting the partly recorded data area comprises detecting an area containing information blocks of the second type. This has the advantage that the information blocks of the second type may be moved without the need to take extent allocation rules into account. Hence only the limited amount of information blocks of the second type needs to be moved. It is noted that in other cases a partly recorded data area may contain some information blocks of the first type, which areas still may be sufficiently cleared by moving other blocks of the second type or part of the information blocks of the first type while taking the extent allocation rules into account.

In an embodiment the method comprises detecting that, during recording of information of the first type and due to the extent allocation requirements, insufficient free data space is available and subsequently suspending said recording, creating said at least one free data area, and resuming recording using the free data area. This has the advantage that recording the information of the first type can be started immediately when required, while only when necessary a minimal amount of time for temporarily suspending the recording process is needed.

In an embodiment the method comprises a first step of temporarily recording of information of the first type without regard for the extent allocation requirements, and subsequently comprises creating said at least one free data area and finally re-arranging the information of the first type according to the extent allocation requirements using the free data area. This has the advantage that recording the information of the first type, which ultimately requires being stored according to the allocation rules, can be started immediately and continued until substantially all data space has been recorded. At a later time, for example as a background process, the information blocks are moved to create the free data areas and accommodate therein the just recorded information blocks of the first type.

In an embodiment the first type of information is defect management information and the extent allocation requirements include a defect management area to be assigned according to defect management area allocation rules, and said creating at least one free data area includes creating a free data area according to the defect management area allocation rules. It is noted that the extent allocation rules in this embodiment are considered to constitute part of the defect management area allocation rules. Specifically clearing the data space according to the defect management area allocation rules allows the defect management areas to be extended as required, although data has already been recorded on the record carrier. As only the specified defect management areas need to be cleared, this has the advantage that only a limited amount of time is needed.

Further preferred embodiments of the device and method according to the invention are given in the appended claims, disclosure of which is incorporated herein by reference.

These and other aspects of the invention will be apparent from and elucidated further with reference to the embodiments described by way of example in the following description and with reference to the accompanying drawings, in which

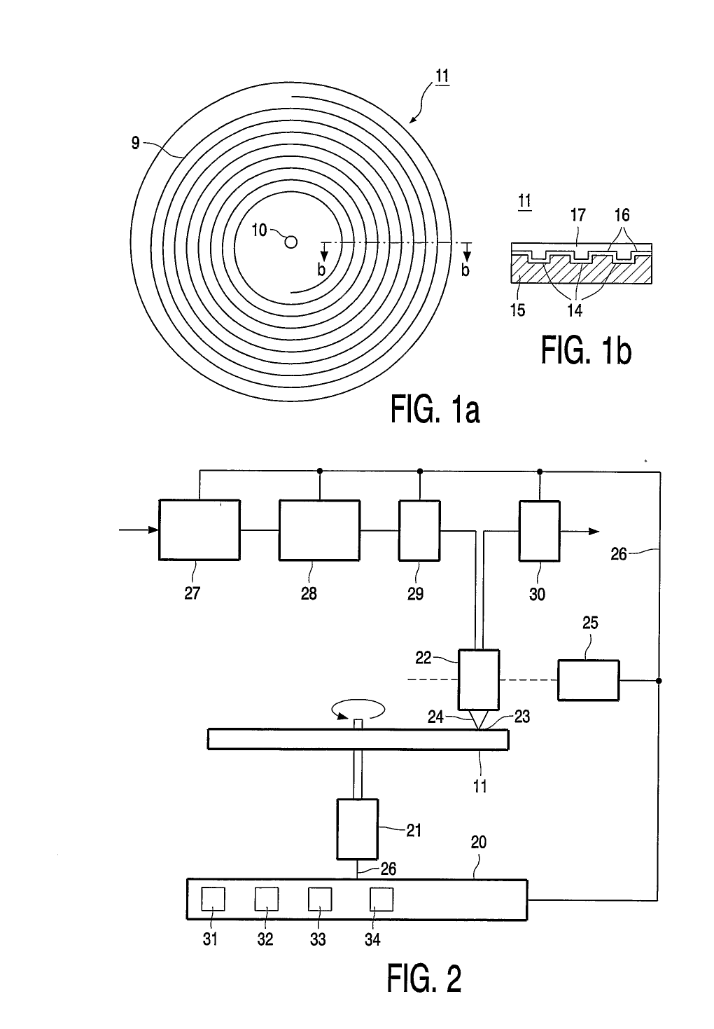

FIG. 1a shows a record carrier (top view),

FIG. 1b shows a record carrier (cross section),

FIG. 2 shows a recording device having a data space management function,

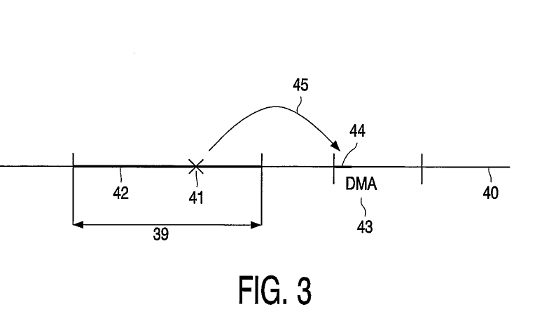

FIG. 3 shows remapping of defective locations, and

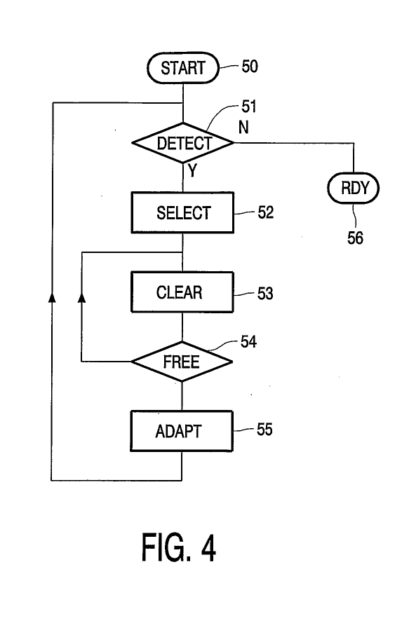

FIG. 4 shows a process of managing data space,

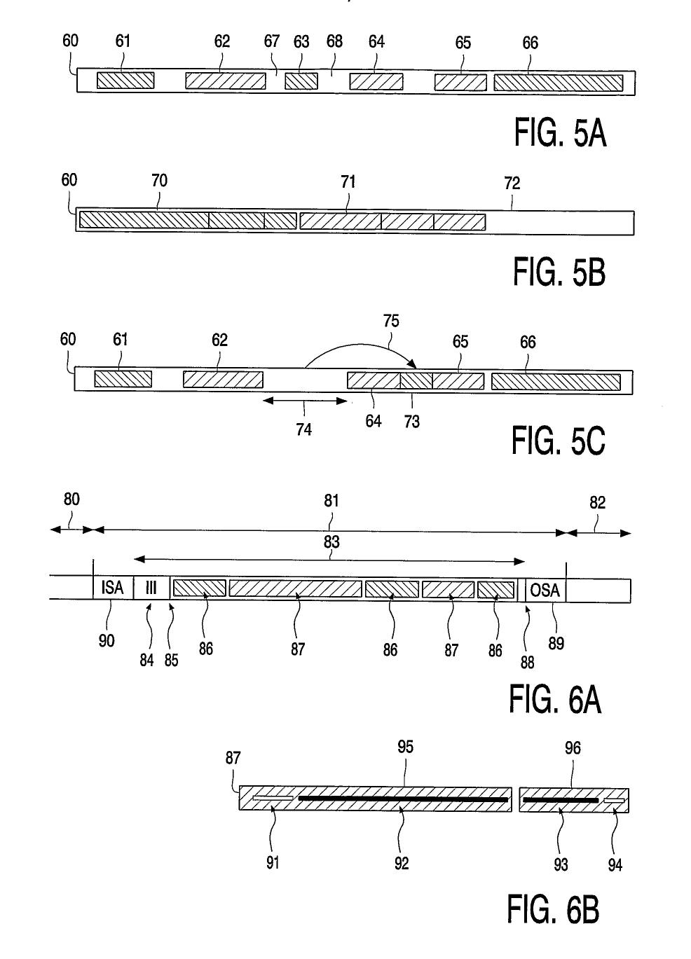

FIG. 5 shows an example of defragmentation and data space management,

FIG. 5A schematically shows a fragmented part of a data zone on a record carrier,

FIG. 5B shows the same data zone after traditional defragmentation,

FIG. 5C shows the same data zone after clearing a free area,

FIG. 6 shows storage of video data on a record carrier,

FIG. 6A shows the recordable area schematically, and

FIG. 6B show the contents of an application file.

Corresponding elements in different Figures have identical reference numerals.

FIG. 1a shows a disc-shaped record carrier 11 having a track 9 and a central hole 10. The track 9, being the position of the series of (to be) recorded marks representing information, is arranged in accordance with a spiral pattern of turns constituting substantially parallel tracks on an information layer. The record carrier may be optically readable, called an optical disc, and has an information layer of a recordable type. Examples of a recordable disc are the CD-RW, and rewritable versions of DVD, such as DVD+RW, and the high density writable optical disc using blue lasers, called Blu-ray Disc (BD). Further details about the DVD disc can be found in reference: ECMA-267: 120 mm DVD—Read-Only Disc-(1997). The information is represented on the information layer by recording optically detectable marks along the track, e.g. crystalline or amorphous marks in phase change material. The track 9 on the recordable type of record carrier is indicated by a pre-embossed track structure provided during manufacture of the blank record carrier. The track structure is constituted, for example, by a pregroove 14 in FIG. 1b, which enables a read/write head to follow the track during scanning. The track structure comprises position information including so-called physical addresses, for indicating the location of units of information, usually called information blocks.

FIG. 1b is a cross-section taken along the line b-b of the record carrier 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

The record carrier 11 is intended for carrying digital information in information blocks having logical addresses under control of a file management system. The information blocks constituting a file are located according to file management data of a file management system, usually the file being subdivided in parts called extents. The extent accommodates a multitude of information blocks in a substantially consecutive range of addresses. The information may be of different types. A first type of information has specific extent allocation requirements related to the function of the information, e.g. real-time information or defect management information each having respective allocation rules. The real-time information is to be recorded and reproduced continuously, and requires contiguous data areas of a minimum size. Defect management requires predefined areas to be available for storing defect management information. Hence the extent allocation requirements include requiring the extent to have at least a predetermined extent size. A second type of information has no extent allocation requirements, e.g. general purpose data storage or computer program files.

In an embodiment the first type of information is real time information and the extent allocation requirements are to guarantee a seamless playback in a predefined playback device. Commonly the real time information includes video information, and seamless playback on standardized players is provided by defining the extent allocation requirements based on the properties of the standard device. Different sets of requirements may be defined for different types of information. For example, digitally encoded video according to a standardized format like MPEG2 as broadcasted may have a minimum extent size of 13 MB (megabyte), whereas video data from a digital camcorder (having a higher data rate) may require a minimum extent size of 26 MB.

FIG. 2 shows a recording device having a data space management function. The device is for writing information on a record carrier 11 of a type, which is re-writable, for example CD-RW, DVD+RW or BD. The device is provided with recording means for scanning the track on the record carrier, which means include a drive unit 21 for rotating the record carrier 11, a head 22, a positioning unit 25 for coarsely positioning the head 22 in the radial direction on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning the spot 23 in a radial direction on the center of the track. The tracking actuator may comprise coils for radially moving an optical element or may alternatively be arranged for changing the angle of a reflecting element. For writing information the radiation is controlled to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material. For reading the radiation reflected by the information layer is detected by a detector of a usual type, e.g. a four-quadrant diode, in the head 22 for generating a read signal and further detector signals including a tracking error and a focusing error signal for controlling said tracking and focusing actuators. The read signal is processed by read processing unit 30 of a usual type including a demodulator, deformatter and output unit to retrieve the information. Hence retrieving means for reading information include the drive unit 21, the head 22, the positioning unit 25 and the read processing unit 30. The device comprises write processing means for processing the input information to generate a write signal to drive the head 22, which means comprise an (optional) input unit 27, and a formatter 28 and a modulator 29. During the writing operation, marks representing the information are formed on the record carrier. The marks are formed by means of the spot 23 generated on the recording layer via the beam 24 of electromagnetic radiation, usually from a laser diode. Digital data is stored on the record carrier according to a predefined data format. Writing and reading of information for recording on optical discs and formatting, error correcting and channel coding rules are well-known in the art, e.g. from the CD and DVD system.

The control unit 20 is connected via control lines 26, e.g. a system bus, to said input unit 27, formatter 28 and modulator 29, to the read processing unit 30, and to the drive unit 21, and the positioning unit 25. The control unit 20 comprises control circuitry, for example a microprocessor, a program memory and control gates, for performing the procedures and functions according to the invention as described below. The control unit 20 may also be implemented as a state machine in logic circuits.

The formatter 28 is for adding control data and formatting and encoding the data according to the recording format, e.g. by adding error correction codes (ECC), interleaving and channel coding. The formatted units comprise address information and are written to corresponding addressable locations on the record carrier under the control of control unit 20. The formatted data from the output of the formatter 28 is passed to the modulator 29, which generates a laser power control signal, which drives the radiation source in the optical head. The formatted units presented to the input of the modulation unit 29 comprise address information and are written to corresponding addressable locations on the record carrier under the control of control unit 20.

The control unit 20 is arranged for controlling the recording by locating each block at a physical address in the track, and managing the data space on the record carrier as described below. The control unit includes the following cooperating units: a selection unit 31 for selecting at least one partly recorded data area of at least the extent size which data area contains information blocks at recorded addresses, and a clearing unit 32 for creating a free data area on the record carrier by moving the information blocks from the recorded addresses in the partly recorded data area to different addresses outside the free data area and correspondingly adapting the file management data. The control unit may further contain a real-time storage unit 33 and a defect management unit 34. The units are for example implemented in firmware or logical circuits, but the function of the units may alternatively be performed as a process of data space management in a separate device, for example as a computer program in a host computer controlling a disc drive. Then the drive accommodates physically recording and retrieving of information in blocks on the record carrier.

In an embodiment the recording device is a storage device only, e.g. an optical disc drive for use in a computer. The control unit 20 is arranged to communicate with a processing unit in the host computer system via a standardized interface. Digital data is interfaced to the formatter 28 and the read processing unit 30 directly.

In an embodiment the device is arranged as a stand alone unit, for example a video recording apparatus for consumer use. The control unit 20, or an additional host control unit included in the device, is arranged to be controlled directly by the user, and to perform the functions of the file management system. The device includes application data processing, e.g. audio and/or video processing circuits. User information is presented on the input unit 27, which may comprise compression means for input signals such as analog audio and/or video, or digital uncompressed audio/video. Suitable compression means are for example described for audio in WO 98/16014-A1, and for video in the MPEG2 standard. The input unit 27 processes the audio and/or video to units of information, which are passed to the formatter 28. The read processing unit 30 may comprise suitable audio and/or video decoding units.

The control unit 20 is arranged for translating physical addresses into logical addresses and vice versa in dependence of control data such as mapping information. The logical addresses constitute a contiguous user data storage space to be used for storing sequences of information blocks, such as files under control of a file management system, for example UDF (Universal Disc Format). The mapping information is indicative for translating a logical address to a physical address in the user data zone, and may include defect management information.

FIG. 3 shows remapping of defective locations. Defect management may be performed by the defect management unit 34 in the recording device. A physical address space 40 is schematically represented by a horizontal line. A series of blocks 42 is to be recorded in an allocated physical address range 39. However a defect 41 interrupts the allocated physical address range. Remapping 45 is the process that a block 44 having a logical address corresponding to the physical address 41 that is defective is stored in an alternative physical address in a defect management area (DMA) 43. The remapping information provides data for translating the logical address initially mapped to a physical address exhibiting a defect to an alternate physical address in a defect management area, for example an entry in a secondary defect list including the logical address of the remapped block and its corresponding physical address.

The defect management areas are located on the record carrier according to a recording area layout, and may be part of a system area assigned to system use. In the layout physical address are assigned a specific logical address of a user data area, or to a defect management area or system area, etc. The layout may be predefined, or may be defined according to parameters included in the system area on the record carrier. In particular the layout of system information and/or defect management information may be adapted after user data has already been recorded on the record carrier. In such an embodiment the defect management information is embodying the first type of information as described above, whereas the defect management area layout rules are embodying the extent allocation rules. For example the extent allocation rules for defect management areas may include specific predefined address ranges to be assigned as defect management areas. When changing the defect management layout such areas have to be cleared as described below. Hence in the method below creating the free data areas includes creating a free data area according to the defect management area allocation rules to be used as system area.

FIG. 4 shows a process of managing data space. The process may be embedded in the selection unit 31 and the clearing unit 32 in the device described with reference to FIG. 2. Alternatively the process of managing data space may be partly or completely embedded in a control program to be executed on a host processor coupled to the recording device, e.g. driver software in a computer operating system. At START 50 a record carrier is available that has been partly recorded and contains information blocks at recorded addresses. In a first step DETECT 51 it is detected if free areas are needed for recording information of the first type, i.e. having extent allocation requirements. The allocation requirements at least include a minimum extent size, or the minimum extent size may be derived based on the allocation requirements. The step DETECT 51 may be based on a user command, on a received command for storing data of the first type, or it may be triggered by other events such as idle time of the device for starting a background process. If a free area is needed, in next step SELECT 52 at least one partly recorded data area is selected that is to be cleared to a free area according to the extent allocation rules, e.g. at least having a required size. The selected data area will contain information blocks at recorded addresses. In a next step CLEAR 53 a free data area is created on the record carrier. The information blocks from the recorded addresses are read from the recorded addresses in the partly recorded data area and re-recorded to different addresses outside the free data area for moving the information blocks. In a step FREE 54 it is detected if further information blocks need to be moved to clear the area. If not, in a next step ADAPT 55, the file management data is adapted corresponding to the new location of the moved information blocks. It is noted that preferably the file management data is updated after moving the information blocks but before starting to use the free area, in particular to prevent inconsistent file management data if an interruption of the clearing process is forced, e.g. by a power failure. The process continues with step DETECT 51. If no further free areas are needed the process is completed at READY 56.

It is noted the extent allocation requirements may include further rules. For example an application could have an allocation strategy in which allocation is required in multiples of a certain number of blocks or extent sizes. Let a free area of e.g. 1.7 times the extent size be available. Although this is larger than the extent size, the additional rules would prefer a multiple of 2 units, and efforts could be made to expand this area to 2.0 times the extent size to allow for the allocation of a single extent according to the multiple strategy, i.e. with a size of two times the minimum extent size.

In an embodiment the detecting in step DETECT 51 proceeds as follows. First a recording command is received for recording a file of first type information, which command includes file size data indicating the size of the file, e.g. copying an existing file. The command may also include the type of information, or the specific extent allocation rules. From the file size data a need for free areas is derived, each free area having at least the extent size. Subsequently available free data space is detected. If the available free data space is scattered and includes areas smaller than the extent size, a need for clearing free areas is detected. Subsequently a set of sufficient additional free data areas is defined and cleared to accommodate recording the file according to the extent allocation requirements.

Alternatively the type of information or the file size may be automatically detected from characteristics-of the command, such as the file size, or a pattern of repetitive writing commands.

In an embodiment the selecting of the partly recorded data area in step SELECT 52 proceeds as follows. Obviously selecting the partly recorded data area first includes detecting already free areas. If such already free areas are too small, i.e. smaller than the extent size, it is detected which information blocks have to be moved. When several potentially clearable areas have been found, a further selection is based on detecting the potentially clearable data area containing information blocks of the second type. It is noted that such information blocks may be moved without restrictions relating to extent allocation rules. If all potentially clearable also contain information blocks of the first type, the further selection may be based on moving also some information blocks of the first type. In particular extent allocation rules of the information blocks to be moved have to be taken into account. However, such extent allocation rules may be different, or such information blocks may be moved towards or together with further information blocks of the existing file to comply with the extent allocation rules. It is noted that, when moving the information blocks of the second type in the partly recorded data area that are part of a file, such information blocks may initially be contiguous with other information blocks of that file, e.g. a part of the file extending beyond the potentially clearable area. After moving the information blocks the degree of fragmentation of the file of the second type may be increased.

In an embodiment the detecting in step DETECT 51 proceeds as follows. This embodiment may be used for real-time recording, provided sufficient buffer space is available. First a process of recording of information of the first type is started. During the recording, i.e. operating in parallel, it is detected that insufficient free data space is available to continue recording in view of the extent allocation requirements. Subsequently the recording is suspended, and at least one free data area is created. Next the recording is resumed, and the free data area just cleared may be used, while detecting in parallel continues. Alternatively the detecting may be postponed to until after initially recording, e.g. recording real time data temporarily because the real time data cannot be stopped or buffered. The initial recording process does not comply with the extent allocation requirements, and may be considered as a step of temporarily recording of the information of the first type without regard for the extent allocation requirements. Subsequently it is detected that the extent allocation requirements have been violated, and at least one free data area is created. Finally the information of the first type is re-arranged according to the extent allocation requirements using the free data area.

In an embodiment the selecting and clearing in the above steps 52,53 proceed as follows. Here the extent allocation requirements include a skipped block rule. The skipped block rule specifies a limited number of interruptions of the substantially consecutive range of addresses of the extent, and may specify further rules for such interruption. For example a maximal amount of skipped blocks in a window of a predefined size, or in the extent size, may be prescribed. Also the individual interruption may have a maximum length. The skipped block rule is also applied when managing data space, which allows using a record carrier having for example small defective areas or non-movable control data. The clearing step creates the free data area with a number of non-free addresses complying with the skipped block rule.

FIG. 5 shows an example of defragmentation and data space management. A part of a data zone 60 on a record carrier is shown in different states having the same information stored thereon. Extents of files are shown as hatched rectangles representing extents, a first file (named A hereafter) 61,63,66 showing dark hatching, and a second file (named B hereafter) 62,64,65 showing light hatching.

FIG. 5A schematically shows a fragmented part of a data zone on a record carrier. The file A has three extents Al 66, extent A2 61 and extent A3 63, and the file B also has extent B1 62, extent B2 65 and extent B3 64. The fragmented state is shown by the extent order in the Figure, leaving a number of small free data areas 67,68.

FIG. 5B shows the same data zone after traditional defragmentation. The file A is now showing as a single contiguous extent 70 at the beginning, followed by the file B as a single extent 71 and a contiguous free area 72. It is to be noted that for this defragmentation substantially all data has been moved. In the defragmentation processes the goal is to optimize the file access and reading performance by putting various extents of single files as much together as possible, thereby creating contiguous files on the disc. To further optimize the performance also the files are put together as close as possible to minimize jump times between the files. On a typical defragmented disc all files can be found on the inside and all individual files are contiguous on the disc (i.e. all files consist of a single extent). That automatically leads to a large contiguous area of free space on the outer side of the disc. The disadvantage of the traditional defragmentation process is that it may take a long time to complete.

FIG. 5C shows the same data zone after clearing a free area. Only one extent, the extent 63 from FIG. 5A, has been moved to a new location 73 as shown by arrow 75. A free data area 74 has now been cleared, which size is sufficient to accommodate the minimum extent size of first type date to be recorded. This is the result of the new defragmentation process that takes the minimum extent size into consideration. The target of the new defragmentation process is to create one (or more) contiguous free data areas on the disc with at least a certain size. This new defragmentation process is finished as soon as possible. There is no need to create free areas that are larger than the extent size. Hence processing time for clearing is limited, because clearing large free spaces takes a lot more time. Furthermore the amount of fragmentation of the files of the second type is not of particular interest when recording new first type information.

If one compares the amount of data (in FIGS. 5B and 5C) that has to be shifted (copied) from one location to another location it is clear that the solution presented in FIG. 5C requires much less data to be shifted. That will result in an enormous time gain, while the result is good enough for accommodating the extent size of the new data of the first type.

Other examples of clearing are of course possible. An option would be to split a single extent in two or more extents, thereby even increasing the amount of fragmentation of the existing files on disc. Of the former single extent that now is split in two one of the new extents is moved to another location on the disc. Thereby a free data area is created sufficient for the extent size to be recorded to disc. For example, if one wants to write in total e.g. 26 MB of video data requiring an extent size of 12.5 MB, there are various options. A first option is to create a single contiguous free data area on the disc that has a size of at least 26 MB. A second option is to create two free data areas of 12.5 MB and one of 13.5 MB. Obviously it is not an option to create a free data area of 10 MB and one of 16 MB.

In a practical embodiment the system for recording real-time data while applying data space management in a UDF file system environment is as follows. In the device described with reference to FIG. 2 the real-time storage unit 33 is arranged for recording real-time information while appropriately managing file system information. For example, for the Blu-ray Disc Video application the so-called BDFS (Blu-ray Disc File System) has been defined, which video application has extent allocation rules. A so-called virtual volume according to the extent allocation rules may be stored in a standard file, which basically puts all BDFS structures and related video data in a single UDF file.

FIG. 6 shows storage of video data on a record carrier. FIG. 6A shows the recordable area schematically. The area start with a lead-in zone 80 followed by a data zone 81 and a lead-out zone 82. The data zone contains an inner spare area (ISA) 90, a UDF zone 84 containing a UDF anchor and partition information, followed by a UDF partition between a UDF partition start 85 and a UDF partition end 88, followed by a outer spare area (OSA) 89. The user data area 83 is located between the ISA and the OSA, and contains various extents 86 of File System information and File data, and also some extents of a video application file 87 containing the application structure, for example according to the BDFS system.

FIG. 6B show the contents of an application file. The content of video application file 87 are according to the BDFS system, and start with BDFS control data 91, followed by video application data 92,93 (real time files and control data), and concluded by BDFS control data 94. Note that the video application file 87 is subdivided in a first extent 95 and a second extent 96 which are stored separately on the record carrier according to the UDF file system as indicated in FIG. 6A.

An important aspect of the BDFS file system is the set of allocation rules for the video content. These allocation rules must guarantee seamless real-time playback of the video content in BD players. Basically the allocation rules can be summarized in a rule that each individual video file part (extent) has a certain minimum size of 12.5MB or 25MB depending on the type of video. Such a video extent is logically and physically contiguous on disc. As shown in FIG. 6 the BDFS structures and related video data are stored in a single UDF based file. The allocation requirements, namely the allocation of the UDF file with the BDFS data, are maintained by the data space management according to the invention to guarantee seamless playback. Hence the extent allocation rules of the video application file 87 are to be applied when allocating the extents in the UDF system. The extent allocation rules from the video application are applied when creating free data space for recording extents in the UDF file system.

Although the invention has been explained mainly by embodiments using a DVD+RW or BD defect management system, similar defect management systems used for other types of record carriers are suitable for applying the invention. Also for the information carrier an optical disc has been described, but other media, such as a magnetic hard disk, can be used. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1-11. (canceled)

12. Method of managing data space on a record carrier for use in recording information in blocks located according to file management data of a file management system, which information comprises
a first type of information having extent allocation requirements that include requiring an extent to accommodate a multitude of information blocks in a substantially consecutive range of addresses and the extent to have at least a predetermined extent size, and
a second type of information having no extent allocation requirements,
which method comprises,
selecting at least one partly recorded data area of at least the extent size which data area contains information blocks at recorded addresses, said selecting the partly recorded data area comprising detecting an area containing information blocks of the second type, and
creating a free data area on the record carrier by moving the information blocks from the recorded addresses in the partly recorded data area to different addresses outside the free data area and correspondingly adapting the file management data.

13. Method as claimed in claim 12, wherein the information blocks of the second type in the partly recorded data area are part of a file and are contiguous with information blocks of the second type extending beyond the partly recorded area.

14. Method as claimed in claim 12, wherein the first type of information is real time information and the extent allocation requirements are to guarantee a seamless playback in a predefined playback device, in a particular case the real time information including video information.

15. Method as claimed in claim 12, wherein the method comprises detecting that, during recording of information of the first type and due to the extent allocation requirements, insufficient free data space is available and subsequently suspending said recording, creating said at least one free data area, and resuming recording using the free data area.

16. Method as claimed in claim 12, wherein the method comprises a first step of temporarily recording of information of the first type without regard for the extent allocation requirements, and subsequently comprises creating said at least one free data area and finally re-arranging the information of the first type according to the extent allocation requirements using the free data area.

17. Method as claimed in claim 12, wherein the extent allocation requirements include a skipped block rule allowing a limited number of interruptions of the substantially consecutive range of addresses of the extent, and creating said at least one free data area includes allowing a number of non-free addresses in the free area complying with the skipped block rule.

18. Method as claimed in claim 12, wherein the first type of information is defect management information and the extent allocation requirements include a defect management area to be assigned according to defect management area allocation rules, and said creating at least one free data area includes creating a free data area according to the defect management area allocation rules.

19. Method as claimed in claim 12, wherein the method comprises receiving a command for recording a file of first type information, and subsequently detecting available free data space and creating additional free data areas to accommodate recording the file according to the extent allocation requirements.

20. Device for recording information in blocks on a record carrier, which device comprises
recording means (22) for recording marks in a track on the record carrier representing the information, and
control means (20) for controlling the recording by locating the information blocks in the track according to file management data of a file management system,
which information comprises
a first type of information having extent allocation requirements that include requiring an extent to accommodate a multitude of information blocks in a substantially consecutive range of addresses and the extent to have at least a predetermined extent size, and
a second type of information having no extent allocation requirements,
the control means comprising
selection means (31) for selecting at least one partly recorded data area of at least the extent size which data area contains information blocks at recorded addresses and for detecting data area comprising information blocks of the second type, and
clearing means (32) for creating a free data area on the record carrier by moving the information blocks from the recorded addresses in the partly recorded data area to different addresses outside the free data area and correspondingly adapting the file management data.

21. Computer program product for managing data space on a record carrier for use in recording information, which program is operative to cause a processor to perform the method as claimed in claim 12.
